(19) United States
(12) Patent Application Publication
(10) Pub. No.: US 2023/0059479 A1
(43) Pub. Date: Feb. 23, 2023

(54) TANK WITH INTERNAL SUPPORT STRUCTURE

(71) Applicant: Bennamann Services Ltd., Newquay, Cornwell (GB)

(72) Inventors: Luke James MANN, Truro, Cornwall (GB); Christopher Mark MANN, St. Mawgan, Cornwall (GB); Thomas William BRADSHAW, Nr Wantage, Oxon (GB); Kate Joanne DIBBLE, Wadebridge, Cornwall (GB)

(73) Assignee: Bennamann Services Ltd., Newquay, Cornwall (GB)

(21) Appl. No.: 17/792,590

(22) PCT Filed: Jan. 15, 2021
(86) PCT No.: PCT/IB2021/050274

§ 371 Date: Jul. 13, 2022

Related U.S. Application Data
(60) Provisional application No. 62/962,414, filed on Jan. 17, 2020.

(51) Int. Cl. F17C 3/08

(52) U.S. Cl. CPC F17C 3/08; F17C 2201/0147; F17C 2203/013; F17C 2203/016; F17C 2203/0391; F17C 2203/0629; F17C 2203/0643; F17C 2203/0663

(57) ABSTRACT

Systems and methods for storing materials, such as cryogenic materials, with inner and outer vessels of a storage tank that mutually support each other. An inner vessel may also have a webbing, such as a rope lattice, that provides additional support for the storage tank.

### TECHNICAL FIELD

Disclosed are embodiments relating generally to storage tanks, and in particular the cryogenic storage of liquid methane, as well as its delivery as fuel, for instance to power generation systems such as engines.

### BACKGROUND

The storage of cryogenic materials, such as liquid methane, and its delivery as a fuel to engines and other power generation systems can present several technical challenges as compared to conventional, non-cryogenic liquid fuels such as diesel, gasoline, and butane.

For example, in terms of storage, to minimize the loss of methane gas through venting, a typical storage tank 100 is illustrated in FIG. 1. Often, such a tank is able to extend the period over which the methane can remain liquid by storing it in a high-pressure vacuum insulated vessel, and could include an outer vacuum jacket 102, an inner vessel 104, super insulation 106, and an evacuation port 108.

Because there is typically vacuum between the outer and inner vessels, and/or further because the inner vessel is typically pressurized, additional support structures may be required. For example, a cryogenic tank may require bunding. External structural supports may waste valuable footprint space, thereby limiting storage volume and increasing weight. Additionally, to accommodate pressure, existing designs may use heavy or thick materials, which can increase costs, lead to unwanted heat transfer, and limit applications. Thus, there remains a need for improved storage tank arrangements, including for use in vehicles.

Additionally, given the pressure constraints of existing systems, storage vessels must typically be cylindrical in cross-section, with a centrally located short pipe for output. One approach to non-cylindrical tank design is provided in WO 2019/102357 by Mann et al., titled “Liquid Methane Storage and Fuel Delivery System,” where embodiments utilize a rope suspension system. However, there remains a need for non-cylindrical shaped tank arrangements, for instance, with alternative support structures.

### SUMMARY

According to embodiments, structural supports are provided between an inner and outer vessel of a storage tank. For instance, rods may be fitted between the two. In certain aspects, the inner vessel has a pressure pushing outwards, and the outer vessel has a vacuum pulling inwards. In this arrangement, the tanks can mutually supporting each other. This can eliminate, for instance, the need for a cryogenic vessel to have large internal bunding on an inner tank and/or additional structural supports for an outer tank.

According to embodiments, a storage tank is provided that comprises an outer vessel, an inner vessel arranged within the outer vessel, and at least a first support system that connects the inner vessel to the outer vessel. The first support system may comprise, for instance, a plurality of rods where each of the plurality of rods is attached to a surface of the inner vessel and attached to a surface of the outer vessel. In certain aspects, the attachment may be a fixed or non-fixed arrangement. In some embodiments, each of the plurality of rods may be partially or completely hollow, for instance, in the form of a tube. In some embodiments, the tank also has a second support system that is located at least partially within the inner vessel, where the second support system comprises a webbing. This may be, for instance, a lattice of rods and/or rope. The storage tank may have a non-cylindrical cross section in some embodiments, and may be an operative component of a vehicle used for purposes other than just fuel delivery or fuel storage. For instance, it may be a wing, structural wall of a vehicle, or other component.

According to embodiments, a storage tank is provided that comprises an outer vessel having a first side surface and a second side surface, and an inner vessel arranged within the outer vessel and having a first opening and a second opening. The outer vessel may comprise a first rod extending between the first side surface and the second side surfaces, while the inner vessel comprises a first hollow tube between the first and second openings. The first rod can be within the first hollow tube. In some embodiments, the tank further comprises a second rod extending between a third side surface and a fourth side surface of the outer vessel, where the inner vessel comprises a second hollow tube arranged between a third and fourth opening and the second rod is located within the second hollow tube. Additionally, the tank may further comprise a third rod extending between a fifth side surface and a sixth side surface of the outer vessel, where the inner vessel comprises a third hollow tube arranged between a fifth and sixth opening and the third rod is located within the third hollow tube. In some embodiments, each of the first, second, and third tubes intersect and are orthogonal. Additionally, one or more of the openings, tubes, and rods can have a varying width (e.g., narrowing towards the center of the tank). For instance, each of opening of the inner vessel has a trumpet-like shape in some embodiments.

According to embodiments, at least one of the tanks described above is mounted on a vehicle and connected to an engine, such that the tank is arranged to deliver methane to the engine. In some embodiments, the tank is the wing of an aircraft. In some embodiments, the tank is part of a fuel delivery system. In some embodiments, the tank is a structural wall of the vehicle.

According to some embodiments, a method is provided. The method may begin with preparing an inner vessel of a storage tank. The method may further comprise preparing an outer vessel of a storage tank, attaching support rods between the inner and outer vessels, and connecting an internal support structure, where the internal support structure comprises webbing within the inner vessel. The webbing may comprise, for instance, rods or a lattice of rope. In some embodiments, connecting the internal support structure comprises tensioning the webbing.

According to some embodiments, a method is provided. The method may begin with preparing an inner vessel of a storage tank having one or more hollow tubes. The method may further comprise preparing an outer vessel of a storage tank, suspending the inner vessel within the outer vessel using a rope suspension system, and inserting one or more rods through the hollow tubes of the inner vessel to fasten the inner and outer vessel together. In some embodiments, the inner and outer vessel each comprises one or more trumpet-shaped openings.

According to some embodiments, one or more designs described herein are scalable to any desired volume, for instance, by adjusting the number and spacing of support elements.

According to some embodiments, the pressure in an inner vessel is used to force the outer vessel walls out via thin walled composite tubes, which, by entering into the inner tank, for instance via recess, can be long and therefore have minimal heat loading.

According to some embodiments, an internal structure can support higher pressures than the outer by incorporating laced rigging internally. This may be made of, for example, rope made of a para-aramid synthetic fiber such as Kevlar®. In certain aspects, a loop is added at the internal junction between a composite tube and outer stainless steel tube between the inner and outer tanks and pulled tight before welding the inner tank shut. The wall thickness can then be made thin as the pressure of the inner tank is used to force the outer out until the rope rigging pulls tight. According to embodiments, a material such as Kevlar's strength will increase dramatically as it gets cold, and thus, higher pressures can be contained and even thinner walls use. This can allow, in some embodiments, the tank to be formed by pressing thin sheets of stainless steel.

According to embodiments, a vehicle is provided. The vehicle may be, for example, a car, lorry/truck, or tractor. Other examples may include sea or air vehicles, such as boats and aircraft. The vehicle comprises an engine and a tank according to any of the foregoing embodiments, where the tank is configured to deliver fuel to the engine. In certain embodiments, the fuel is methane. In some embodiments, the engine is a combustion engine. Other engines may be used, including a flameless heat engine that runs, for instance, on methane.

According to some embodiments, disclosed designs can allow arbitrary shape to be configured and the tank operated at relatively high pressure. The pressure in the tank pulling against the rigging provides counteracting forces that give it additional strength, meaning the tank can be used as a structural support. One example would be an aircraft wing. Another might be a space rocket fuselage. Another example is a complicated fuel tank for a car, lorry/truck, or tractor. By way of example, applications can relate to any arrangement that uses an inner and outer skin.

According to embodiments, a fuel delivery system is provided, comprising: a storage tank according to any of the foregoing; one or more compressors coupled to the storage tank and configured to pressurize methane from the storage tank; and a power unit coupled to at least one of the compressors. The power unit is configured to operate using pressurized methane from the at least one compressor. The power unit may be an engine.

According to embodiments, a method of operating a vehicle is provided, where the vehicle has a storage tanking according to any of the foregoing. The method may include, for example, filling the storage with methane and operating the vehicle with an engine powered by the methane. In some embodiments, the storage tank has a square or rounded rectangular shape in cross-section and at least 6 sides.

According to embodiments, a method of operating a vehicle is provided, where the vehicle has a storage tanking according to any of the foregoing. The tank may be, for example, a low pressure tank. The method may include: extracting methane from the tank; generating pressurized methane by compressing the extracted methane; and operating a power unit of the vehicle using the pressurized methane. In some embodiments, the storage tank has a square or rounded rectangular shape in cross-section. In some embodiments, the method comprises processing the extracted methane with a heat exchanger. Additionally, the method may comprise delivering one or more of the extracted methane and the pressurized methane to a buffer, and passing methane stored in the buffer to the storage tank. This delivery can include the use of a pressure booster and second compressor. In some embodiments, the method comprises generating energy with an auxiliary power unit using methane from the storage tank, and performing one or more of heating a vehicle passenger area, operating the heat exchanger, and starting up the vehicle using the generated energy from the auxiliary power unit. Additionally, in certain aspects, one or more of the extracting, processing, generating pressurized methane, delivering, passing, generating energy, and performing can be in response to a demand for gaseous methane. The methane from the storage tank can be one or more of the methane stored in the buffer and the methane processed by the heat exchanger.

### BRIEF DESCRIPTION OF THE DRAWINGS

The accompanying drawings, which are incorporated herein and form part of the specification, illustrate various embodiments.

FIG. 1. illustrates a storage tank.

FIG. 2 illustrates an outer vessel of a storage tank according to some embodiments.

FIG. 3 illustrates an inner vessel of a storage tank according to some embodiments.

FIG. 4A illustrates a storage tank according to some embodiments.

FIG. 4B is a cross section of a storage tank according to some embodiments.

FIGS. 5A and 5B illustrate a storage tank according to some embodiments.

FIGS. 6A, 6B, and 6C illustrate cross sections of a storage tank according to some embodiments.

FIG. 7A illustrates an outer vessel of a storage tank according to some embodiments.

FIG. 7B illustrates an inner vessel of a storage tank according to some embodiments.

FIG. 7C illustrates a storage tank according to some embodiments.

FIG. 7D is a cross section of a storage tank according to some embodiments.

FIG. 7E illustrates a storage tank according to some embodiments.

FIG. 7F illustrates an assembly process according to some embodiments.

FIGS. 8A and 8B are flow charts showing methods according to some embodiments.

FIGS. 9A-9D illustrate assembly processes according to some embodiments.

FIG. 10 illustrates a storage tank according to some embodiments.

FIGS. 11A-11H illustrate a connection according to some embodiments.

FIGS. 12A-12D illustrate a storage tank according to some embodiments.

FIG. 13 illustrates a system for the storage and delivery of fuel according to some embodiments.

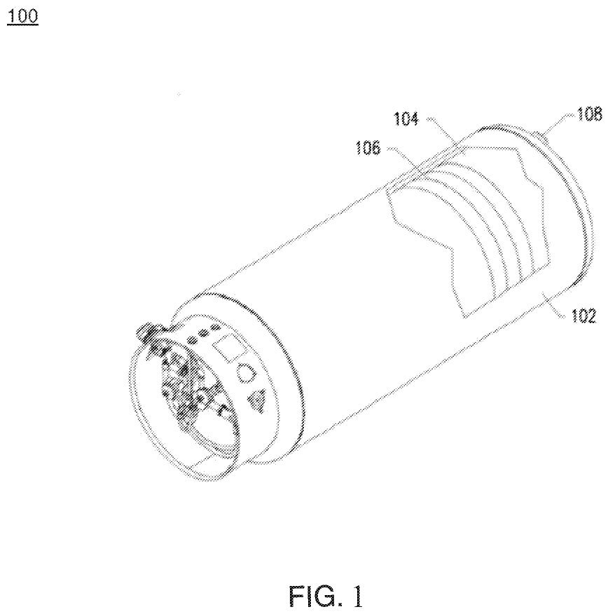

Together with the description, the drawings further serve to explain the principles of the disclosure and to enable a person skilled in the pertinent art to make and use the embodiments disclosed herein. In the drawings, like reference numbers indicate identical or similar functionally.

### DETAILED DESCRIPTION

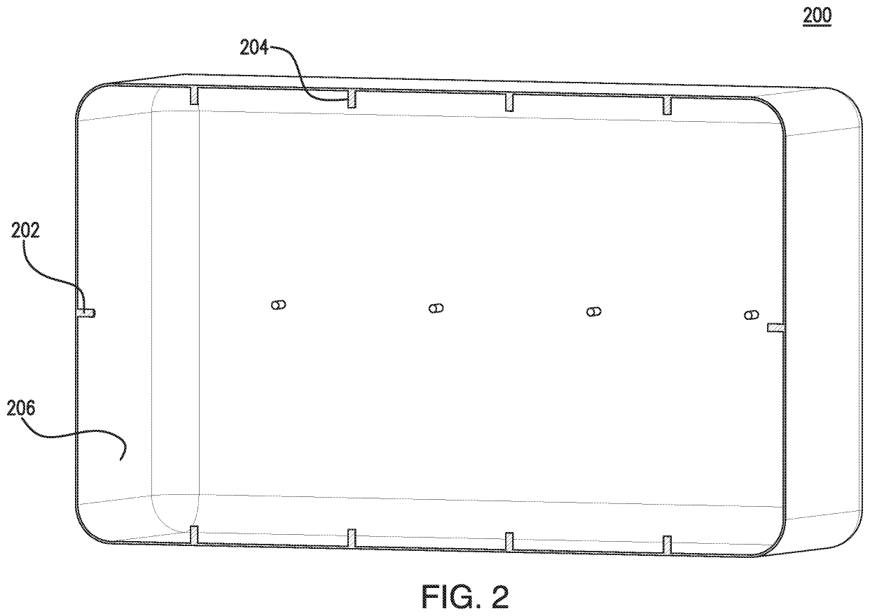

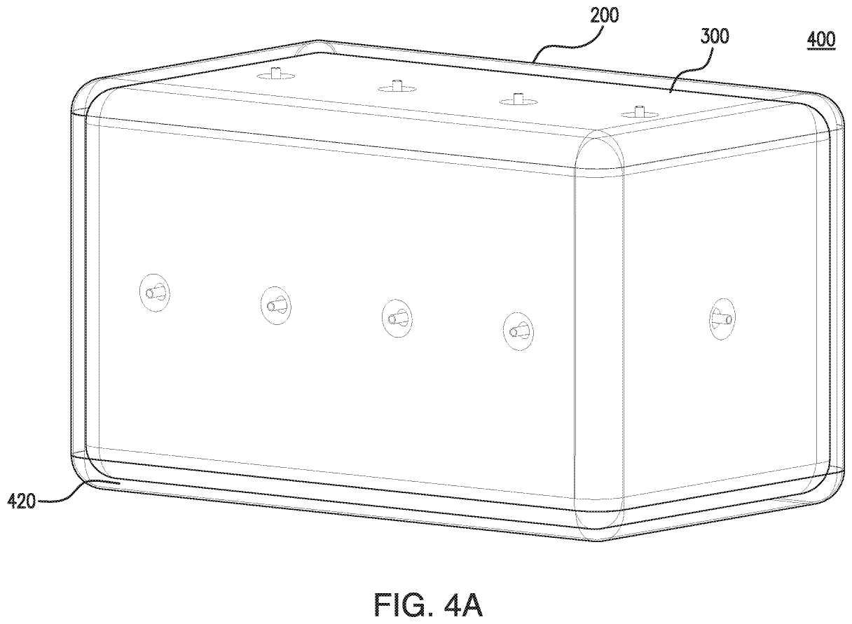

Referring now to FIG. 2, an outer vessel 200 is shown according to some embodiments. The outer vessel 200 may be, for instance, the outermost component of a tank, such as a cryogenic storage tank. In this example, the outer vessel 200 has one or more pins 202, 204 on an inner surface 206 of the vessel. The pins 202, 204 may act as locators and connection points for engagement with an inner vessel or other structural element. For instance, the pins 202, 204 may be sized to fit inside a rod, as illustrated with respect to FIG. 4B. Thus, the locator pins 202, 204 can be spaced to align with an inner vessel's locators. While pins are used in this example, other alignment and connection elements may be used in some embodiments.

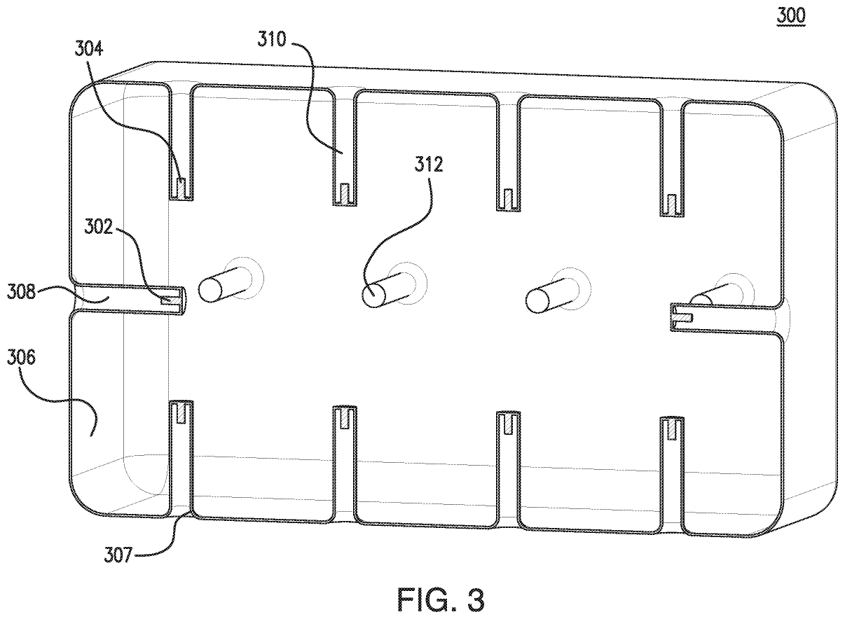

Referring now to FIG. 3, an inner vessel 300 is shown according to some embodiments. The inner vessel 300 may be, for instance, an inner component of a tank, such as a cryogenic storage tank. The inner vessel 300 can be configured to store liquid or gas, such as methane at cryogenic temperatures. In this example, the inner vessel 300 has one or pins 302, 304. According to embodiments, the pins 302, 304 may be located within a recess 308, 310 of the inner vessel's outer wall 307. However, in some embodiments, the pins 302, 304 may be located on a planar outer surface 307 of the inner vessel 300. In some instances, for example to connect to internal structural support, a pin may also be extended on the inner surface 306 of the inner vessel 300. The pins 302, 304 may act as locators and connection points for engagement with an outer vessel, such as outer vessel 200, or other structural element. For instance, the pins 302, 304 may be sized to fit inside a rod, as illustrated with respect to FIG. 4B. Thus, the locator pins 302, 304 can be spaced to align with an outer vessel's locators. While pins are used in the examples of FIGS. 2 and 3, other alignment and/or connection elements may be used in some embodiments, such as washers and adhesives.

According to embodiments, the recesses 308, 310 are tube-shaped regions with end plates 312. Other recess shapes may be used. In the arrangement of FIG. 3, the locating pins 302, 304 are on the outside of the inner vessel 300, and the tube-shaped regions (e.g., recesses 308, 310) are sufficiently large to have a rod inside without contact with remainder of the vessel's surface. The rods can seat on the locating pins, for instance, as illustrated with respect to FIG. 4B. In some embodiments, the rods and pins are configured such that each of the rods is arranged over a pin of the inner and outer vessel, example covers or wraps around the pins, to engage and align both vessels.

According to some embodiments, for instance depending on rod material, a recess may not be required. That is, pins may be located on an outer surface 307 of vessel 300 without a recess. In some embodiments, the pins may be made of the same materials as the respective vessel. For example, the pins 202, 204 may be made of steel and welded to a surface of the outer vessel 200.

Referring now to FIG. 4A, a tank 400, such as a cryogenic storage tank, is shown according to some embodiments. The tank 400 may be used, for instance, for storage and delivery of methane or liquid nitrogen. In this illustration, the tank 400 is shown with an outer vessel 200 surrounding the inner vessel 300. In this example, there is a space 420 between the two vessels. This can, for instance, minimize the heat conduction between the two vessels. This space 420 may be vacuum, and may be at least partially filled, for instance, with another material such as water. Other materials, such as an expanding foam, may be used. According to embodiments, a material in the vacuum space 420 can be wrapped around inner vessel 300, with openings at the locations of recesses 308, 310. For instance, a sheet of multilayer insulation material can be used to limit heat conduction and radiative heat load by attaching it to outer surface 307 of the inner vessel 300. In certain aspects, the material has openings that are co-located with one or more recesses of the inner vessel. In some embodiments, insulating material may applied to an inner surface 206 of the outer vessel 200.

Referring now to FIG. 4B, a cross section of a tank 400 having a support system according to some embodiments is shown. As shown in FIG. 4B, an inner vessel 300 and outer vessel 200 can be interconnected and fixed in place using one or more rods 430, 440. The rods 430, 440 may, for instance, be open at either longitudinal end and engage over both the inner pins 302, 304 and outer pins 202, 204. In certain aspects, the rods 430, 440 may be hollow along their entire length (e.g., a tube). In some embodiments, the outer vessel's locating pins line up with the inner vessel's locating pins so that a rod can be held between the two, as shown in FIG. 4B. The rods may be attached or otherwise connected in a fixed arrangement (e.g., welded or glued) or attached in a non-fixed arrangement, such as in contact or near contact, sufficient to maintain the structure of the tank.

According to embodiments, different materials may be used for the tank, including for the inner vessel, outer vessel, and support structures. For example, the inner and outer vessels may be made of one or more of a composite, stainless steel, aluminum, and copper. The connection pins may be made of similar materials, and in some embodiments, made of stainless steel welded to a surface of the inner and/or outer vessels. The rods may be made of similar materials, and in some embodiments, the rods are made of Kevlar® or a similar para-aramid synthetic material, including a hollow Kevlar® tube. In some embodiments, the outer vessel is made of a metal or composite and the pins are made of the same material as the vessel.

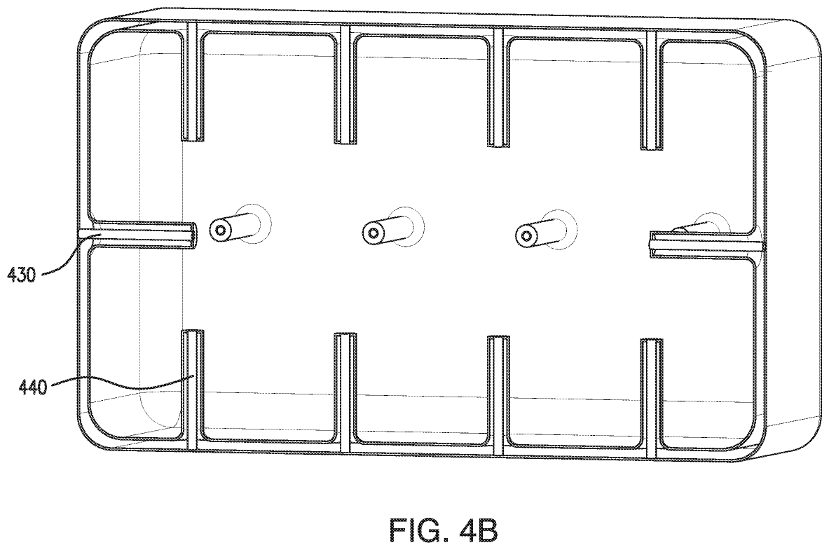

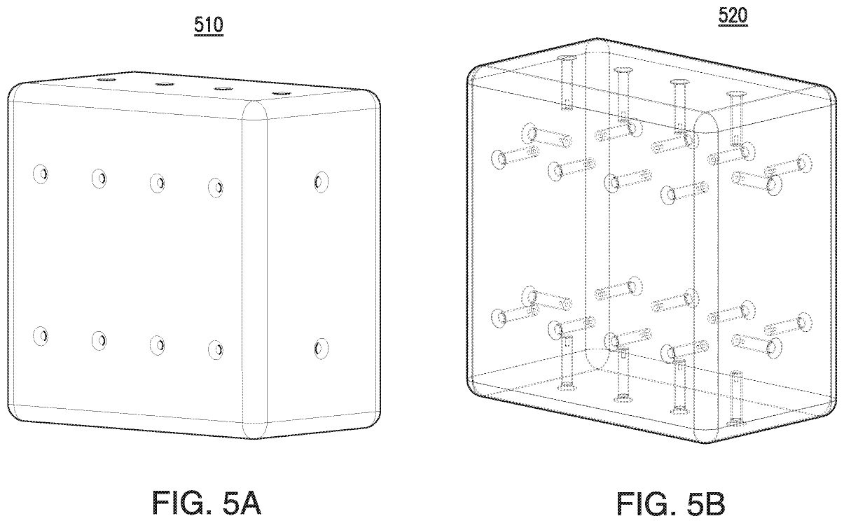

Referring now to FIGS. 5A and 5B, examples of a tank, such as tank 400, are illustrated according to some embodiments. FIG. 5B shows an internal view 520 of the tank 510 shown in FIG. 5A. These figures further illustrate that the vessels and tanks described herein, for instance, with respect to FIGS. 2, 3, 4A, 4B, 6A, 6B, and 10 can be scaled. Thus, while a given example may use a certain number of rows or columns of support elements, such as pins and/or rods, this disclosure is not so limited. For instance, a tank may have 6 sides, with n₁ support elements on a first side, n₂ support elements on a second side, n₃ support elements on a third side, n₄ support elements on a fourth side, n₅ support elements on a fifth side, and n₆ support elements on a sixth side. Examples may include 1×1×4×4×4×4 as shown in FIG. 4B, or 2×2×8×8×4×4 as shown in FIGS. 5A and 5B. According to embodiments, the thickness of the inner vessel may be reduced (or the pressure increased) without loss of stability through the inclusion of additional support elements, such as rods and pins. For example, in some embodiments, if the pressures are kept the same but the area is doubled, then the number of supports is doubled, with the same spacing. As another example, if the pressure is doubled and area kept the same, the spacing may be halved. According to embodiments, tank 400 may have a non-cylindrical cross section, such as a rounded square or rectangle. An “L” shape may also be used in some embodiments.

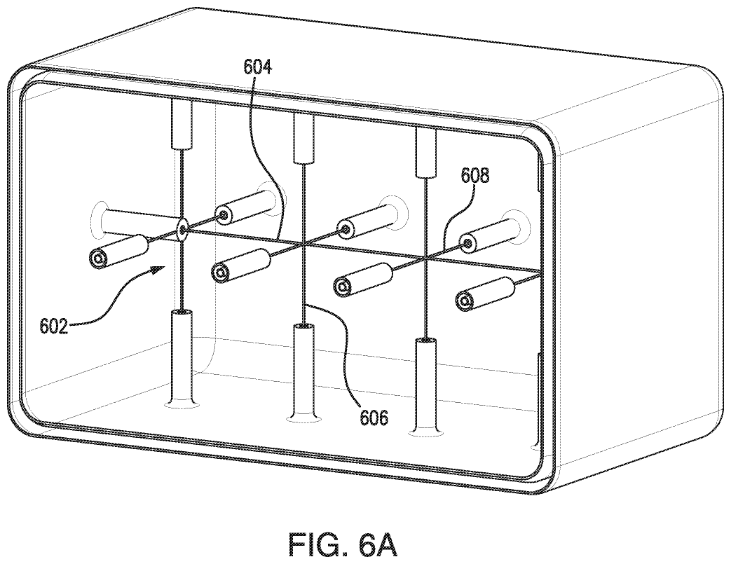

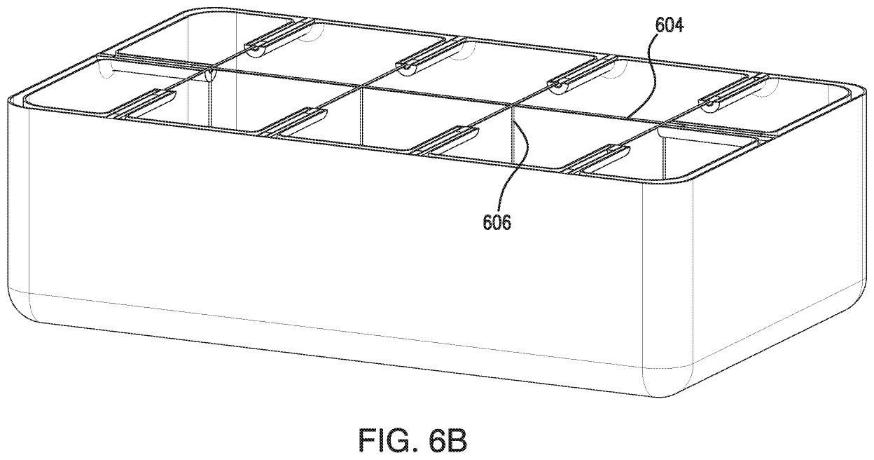

Referring now to FIGS. 6A, 6B, and 6C, cross sections of a tank, such as tank 400, with a second support system are shown according to some embodiments. In this embodiment, a tank further includes an internal support structure 602 located at least partially within the inner vessel. The internal support structure 602 may take the form of a webbing as shown in FIG. 6A, for instance, in a lattice arrangement in which support elements cross. According to embodiments, the webbing lattice may be comprised of multiple rods and/or rope. However, in some embodiments, a single rod or rope may be used for the internal support structure, for instance, depending on volume and pressure constraints.

The support structure can provide additional support for an inner vessel, such as inner vessel 300, enabling, for example, higher pressures, intricate vessel shapes, and/or thinner sidewalls for the vessel. In some embodiments, for instance where the inner and outer vessels are connected by a plurality of rods, the internal support structure similarly supports the outer vessel 200. This can enable, for example, reduction of the outer vessel wall, elimination or reduction in bunding, improved footprints, and material cost savings. The internal support structure 602 may be made of para-aramid synthetic materials such as Kevlar®; however, other materials such as stainless steel or other composites may be used. In some embodiments, the components 604, 606, 608 of the support structure 602 are rope, such as Kevlar® rope or rope of another material. In some embodiments, the components 604, 606, 608 of the internal support structure 602 are rods. For instance, according to embodiments, tanks can be implemented that do not use any rope elements for the internal or outer support systems. The rods of the internal support system may be hollow tubes in some embodiments.

According to embodiments, the internal support structure 602 is comprised of at least horizontal and vertical components 606, 608. The components 606, 608 may be orthogonal to each other such that they form 90 degree angles. However, other embodiments may use components 606, 608 at different angles. Longitudinal components 604 may also be used, and may also be orthogonal to components 606, 608. In certain aspects, the outer support system comprises an n×m×o array of rods in recesses connected to pins, and the inner support system comprises an a×b×c array of rods or ropes having an orthogonal arrangement. In some embodiments, n×m and a×b arrays may be used, respectively. Additionally, one or more of the support systems may be applied in a single direction in some embodiments. For instance, an internal support structure may comprise only components 604, or 606, or 608 in some examples.

As shown in FIG. 6B, for example, the internal support structure 602 may terminate at the wall of the inner vessel, such as inner vessel 300 at plate 312. In some embodiments, the inner support structure may be terminated by, or otherwise connected to, an alignment pin of the inner vessel, such as pins 302, 304 in the example of FIG. 3. Additionally, and in some embodiments, one or more components of the internal support structure 602 may extend through the wall of the inner vessel, for instance, through a support rod, such as rod 430 in the example of FIG. 4B. In some embodiments, one or more components of the internal support structure 602 extend to an outer vessel, such as outer vessel 200. In this example, the internal support structure 602 may be connected to one or more of the inner surface 206 of outer vessel 200, an alignment pin 202, a tensioning element, or an external connector. For instance, one or more elements of the support structure 602 may have a loop for tensioning the support structure. The number of components 604, 606, 608 of the internal support structure 602 may scale with the size of the tank. In some examples, the number scales with the number of locator pins, recesses, and or support rods or tubes.

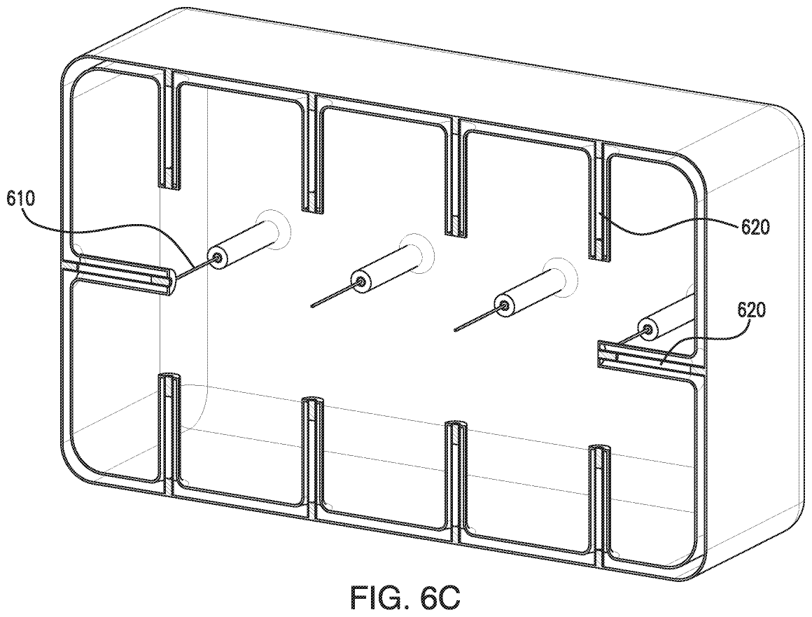

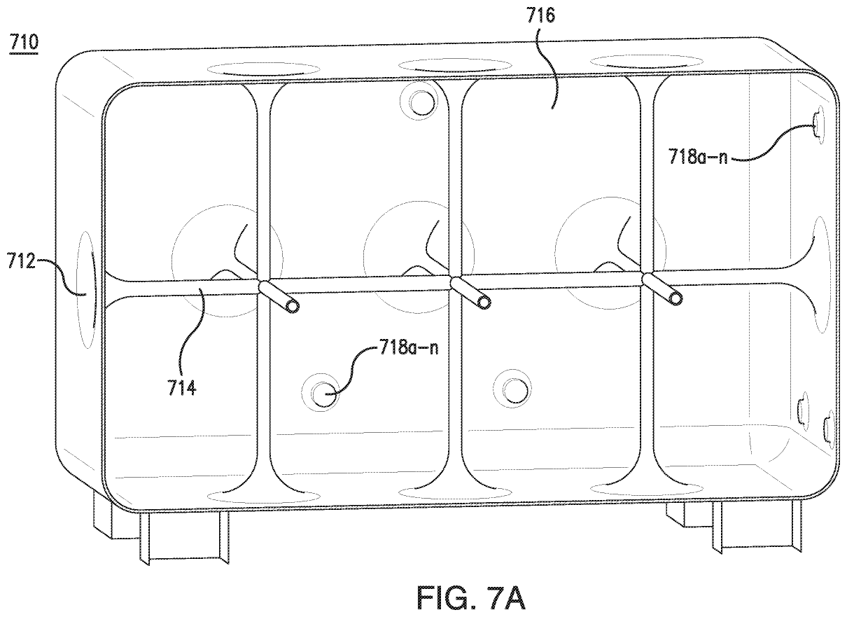

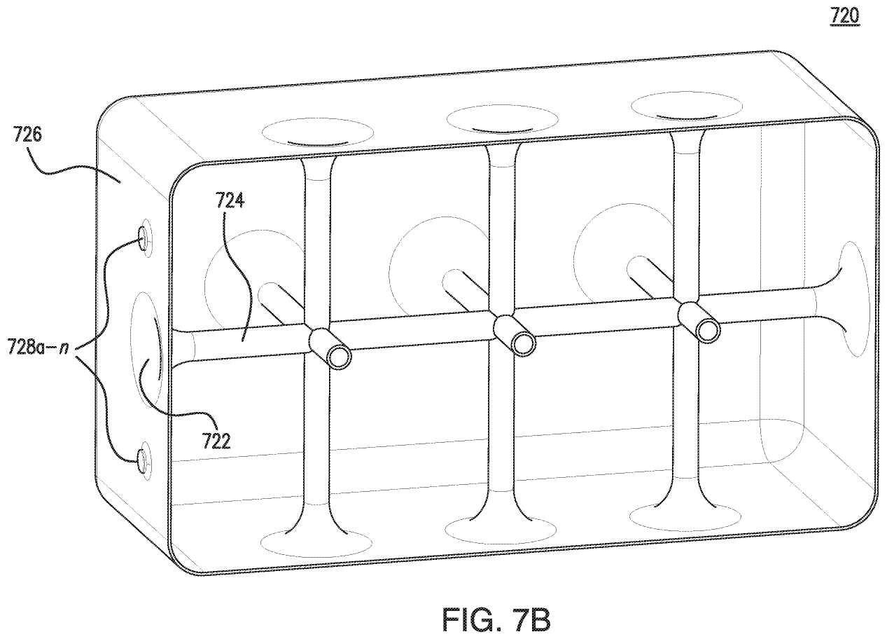

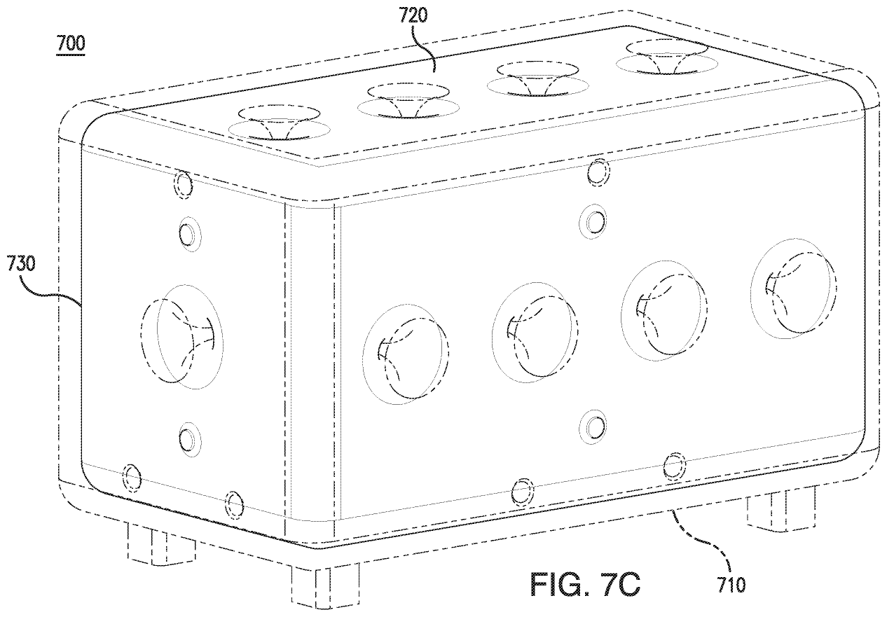

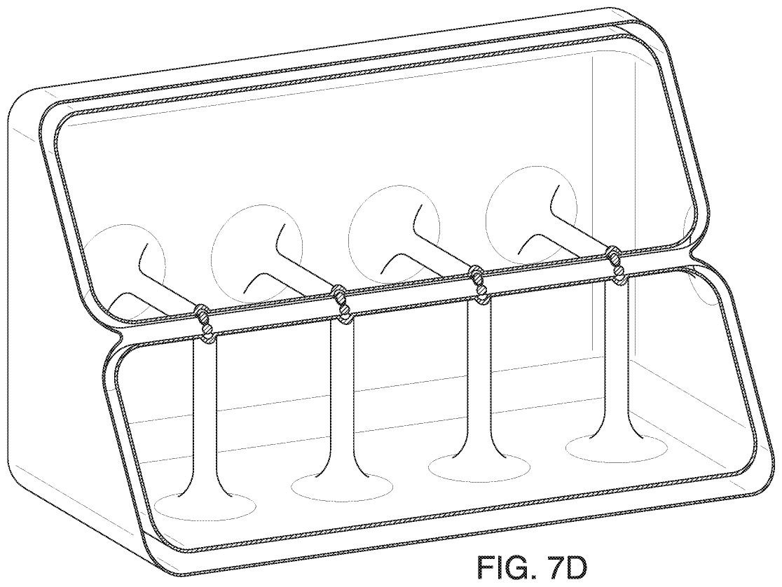

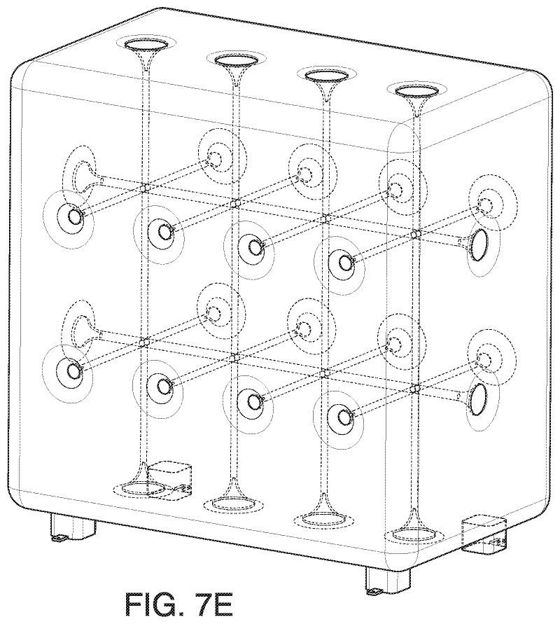

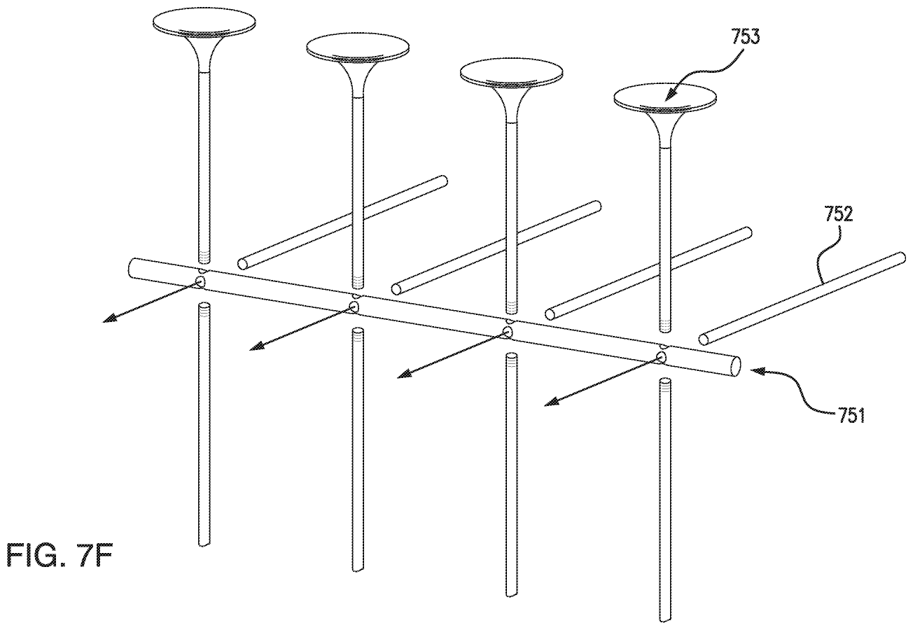

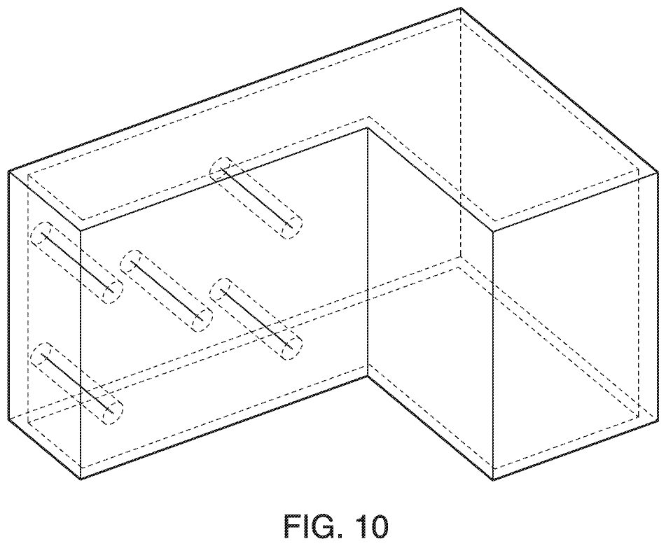

Another view of the assembly shown in FIGS. 6A and 6B is shown in FIG. 6C. In this illustration, aspects of the first, outer support system 620 and second, inner support system 610 are shown. While rods are used as an example of the outer support system 620 in this example, in some embodiments, a rope suspension system could be used to suspend the inner vessel 300 from outer vessel 200. For instance, the vessels may have a plurality of connection points 718, 728 as illustrated with respect to FIGS. 7A-7E, which can be used to attach rope suspensions. The rope suspension system may constrain the movement of inner vessel 300 within outer vessel 200 in all dimensions, including vertical, lateral, and longitudinal directions, as well as a rotational axis. The inner support system 610, such as a webbing or partial webbing 602, could be used for inner support of the suspended inner vessel 300 of the embodiment. In some embodiments, the inner support system 610 may be localized, as illustrated in FIG. 10.

FIGS. 7A-7E illustrate one or more aspects of a tank 700 with a support structure, according to some embodiments.

Referring now to FIG. 7A, an outer vessel 710 according to some embodiments is shown. The outer vessel 710 has supports 712. In this example, the shape of the supports is trumpet-like at the outer surface of vessel 710, such that the supports go down to a point and have a rod 714 that goes to the trumpet on the opposite face. According to embodiments, the rods 714 may be hollow. In some embodiments, the supports 712 and rods 714 are the same component. On an inside surface 716 of the vessel are one or more connection points 718a-n. These connection points may be, for instance, rope connections points such as capstans that are used to hold an inner vessel in place. The connection points may be located on one or more, including all, inner surfaces of the vessel 710. According to embodiments, a tank 700 may use a suspension technique, wherein an inner vessel, such as inner vessel 720 of FIG. 7B, is hung using rope attached the connection points 718a-n. This may, for instance, use Kevlar® rope or rope of another synthetic or composite material for suspension. Based on the location of the connection points 718a-n, the rope suspension system may constrain the movement of inner vessel 720 within outer vessel 710 in all dimensions, including vertical, lateral, and longitudinal directions, as well as a rotational axis. This can help prevent the inner vessel from coming into contact with the outer vessel. In some embodiments, and similarly, the tank 400 may also have one or more connections points as illustrated in FIGS. 7A-7C for use with a rope suspension system. However, tanks 400 and 700 may be implemented without a rope suspension system between inner and outer vessels. In some embodiments, tanks 400 and 700 do not use rope at all. As with tank 400, non-cylindrical shapes may be used for tank 700.

Although illustrated with trumpet shapes in FIGS. 7A-7E, embodiments of tank 700 may not be so limited. For instance, the trumpeted portions of vessel 710 and its support system may be omitted and cylindrical (or near-cylindrical) interfaces used.

Referring now to FIG. 7B, an inner vessel 720 according to some embodiments is shown. In this example, the inner vessel 720 has trumpet-like openings 722 that go down to a tube 724. According to embodiments, the tubes 724 are hollow. The trumpets 722 and tubes 724 have a diameter that fits the outer vessel's supports, such as rods 714, and in some embodiments, a gap to give isolation from the outer vessel. The tubes 724 extend to the trumpet on the opposite side of the vessel. On an outside surface 726 of the inner vessel 720 are connection points 728a-n to hold the vessel in place. These connection points interface with the connection points 718a-n of the outer vessel 710. In some embodiments, they are connections points, such as capstans, for a rope suspension connection. The connection points may be on one or more, including all, outer surfaces of the vessel. As with the outer vessel 710, the trumpet shape may be omitted, and cylindrical (or near-cylindrical) interfaces used.

Referring now to FIG. 7C, an assembled tank 700, such as a cryogenic storage tank, is illustrated according to some embodiments. In this example, there is a space 730, such as a vacuum space, between the inner 720 and outer 710 vessels, which keeps the heat conduction between the two vessels low, as shown in FIG. 7D, which is a cut-away view of tank 700. In this example, the outer vessel's rods go through the inner vessel's tube bunding without any form of contact according to some embodiments. In both the inner and outer vessel, and according to embodiments, the tubes and rods extend in both the horizontal and vertical directions, and are orthogonal to each other, as shown in the examples of FIGS. 7A-7E. However, other arrangements, including rods and tubes in only a single direction, or at angles, may be used.

As shown in the illustration of FIG. 7E, the tank 700 is scalable. This is similar to the scalability described with respect to tank 400 and FIGS. 5A and 5B.

Referring now to FIG. 7F, an assembly method according to some embodiments is illustrated. This method may be used, for instance, to assemble the tank 700. In this example, a main central rod 751 is installed first. Rod 752 the goes through one or more holes in rod 751. Then, rod 753 is screwed into threads of rod 751. Alternatives may include, for instance, welding the rods of 710 together while adding in the tubing needed for the inner vessel 720. Upon completion, in this example, rods 751, 752, and 753 are all orthogonal. In some embodiments, the order of assembly may be changed.

According to embodiments, the inner and outer vessels 710, 720 may be made of one or more of a composite, stainless steel, aluminum, and copper. The trumpets, rods, and/or tubes may be made of similar materials, and in some embodiments, made of stainless steel welded to a surface of the inner or outer vessels. They may also be made of similar materials, and in some embodiments, made of Kevlar®, including a hollow Kevlar® tube or rod.

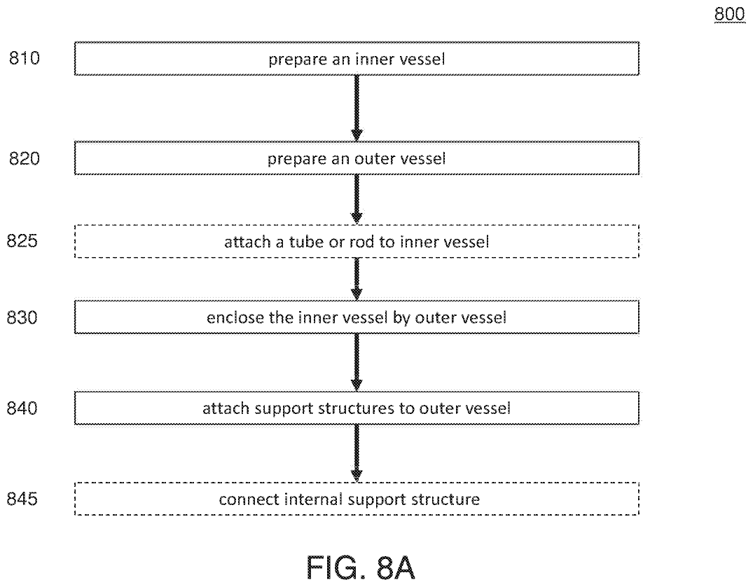

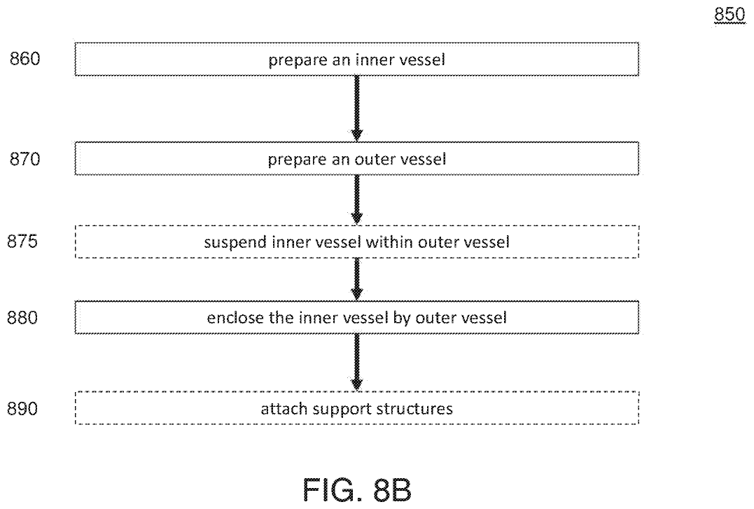

Referring now to FIG. 8A, a method 800 of manufacturing and/or assembling a tank, such as a cryogenic storage tank 400, is provided according to some embodiments. The method may be used, for instance, for a tank as discussed with respect to at least FIGS. 2-6, 10, and 12.

In step 810, an inner vessel is prepared. This may include manufacturing or otherwise obtaining an inner vessel, such as vessel 300. Such manufacture may include, for instance, rolling steel, shaping one or more recesses and their end plates, welding or otherwise attaching pins, or applying an insulation or vacuum wrap.

In step 820, an outer vessel is prepared. This may include, manufacturing or otherwise obtaining an outer vessel, such as vessel 200. Such manufacturing may include, for instance, rolling steel and attaching guide pins. As with step 810, an insulation wrap may be applied.

In some embodiments, a step 825 is provided, in which a tube or rod is attached to at least the inner vessel. This could include, for instance, placing one or more rods or tubes 430 over connection pins 302, 304.

In step 830, the inner vessel is enclosed by the outer vessel.

In step 840, support structures are attached to the outer vessel. This could include, for instance, welding an end of the rods or tubes 430 and alignment/connection pins 202, 204 to the outer vessel. The end of rods or tubes 430 may be placed over pins 202, 204. According to embodiments, one or more washers or an adhesive can be used for attachment. In certain aspects, the attachment is a fixed or non-fixed arrangement.

In some embodiments, a step 845 is provided, in which an internal support structure, such as support structure 602, having a webbing or rope lattice, is connected. This may include one or more of tensioning the support structure and fastening the support structure, for instance, to the inner or outer vessel. According to embodiments, step 845 may be performed after step 840. However, step 845 may be performed at other times, including as part of preparing the inner vessel 810 or enclosing step 830. The support structure 602 may comprise one or more rods.

Referring now to FIG. 8B, a method 850 of manufacturing and/or assembling a tank, such as a cryogenic storage tank 700, is provided according to some embodiments. The method may be used, for instance, for a tank as discussed with respect to any of FIGS. 7A-7E, 10, and 12.

In step 860, an inner vessel is prepared. This may include, manufacturing or otherwise obtaining an inner vessel, such as vessel 720. For instance, the inner vessel may have one or more trumpet and tube support elements.

In step 870, an outer vessel is prepared. This may include, manufacturing or otherwise obtaining an outer vessel, such as vessel 710. For instance, the outer vessel may have one or more openings for a trumpet and rod support element.

In some embodiments, a step 875 is provided, in which an inner vessel is suspended within an outer vessel. This could include, for instance, suspending vessel 720 within vessel 710 using rope connection points 718, 728.

In step 880, the inner vessel is enclosed by the outer vessel.

In step 890, support structures, such as the rods, are attached. This could include, for instance, inserting one or more rods 714 through the assembly, and then welding one or more trumpets 712 into place on the outer vessel 710 along with the rods 714.

According to embodiments, step 890 may be performed as part of a different step, or at a different time in the process 850.

According to some embodiments, a storage tank may be implemented on a vehicle. As used herein, the term vehicle includes, but is not limited to, ground-based vehicles, such as cars, trucks, motorcycles, and tractors; sea-based vehicles, such as boats; and air-based vehicles, such as airplanes or drones.

According to embodiments, a fuel delivery system for a vehicle can be implemented with or more tanks, such as tanks 400, 700, or vessels 200, 300, 710, 720. In embodiments, one or more of tanks 400, 700 and their respective vessels have inlets and outlets for liquid or gaseous fuels. For instance, piping from one or more faces of the tanks 400, 700 may be used for access or decanting. The piping need not be centrally located on a given face. For instance, fuels may enter or exit the tank near an edge.

Although some examples are described with respect to Kevlar®, other fibrous materials, including synthetic fibers such as other para-aramid synthetic fibers can be used. For instance, other materials that maintain strength and resilience over a broad temperature range, including down to cryogenic temperatures may be used. According to some embodiments, the rope material used for the support system of the inner tank can have the specific properties of high strength, and very low thermal conductivity and low elasticity over many years. For some vehicle applications, the UN R110 regulations require that the tank must be able to withstand an impact deceleration or acceleration of 9G in any axis. The testing process also includes a 9 meter drop without liquid release for 60 minutes, which can result in even higher forces in order for the support system to survive and yet not allow rapid heat ingress. Therefore, in certain embodiments, the material is not only able to support the tank and pressure under normal conditions, but orders of magnitude more. In addition, the integrity of the vacuum insulation must be maintained to avoid heat ingress, as well as the quality of the stored liquid or gas (e.g., methane), and so the material has low outgassing properties in some embodiments. According to embodiments, the tank is designed to withstand 5G in the horizontal directions.

According to embodiments, an assembly method is described. In certain aspects, assembly may include preparing an inner vessel (e.g., with support webbing), connecting pins and tubing, preparing an outer vessel around the inner vessel, attaching supports to the inner vessel, and attaching supports to the outer vessel. This may include tensioning or otherwise fixing the support webbing. In some embodiments, this may be a part of process 800. According to some embodiments, support elements may be attached using one or more connection points on a surface of the inner or outer vessel.

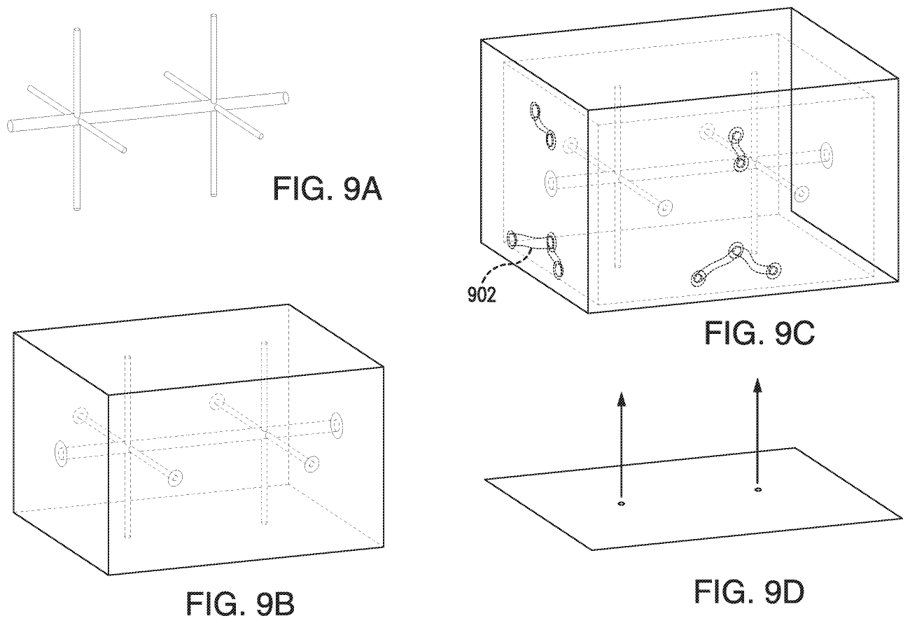

Referring now to FIGS. 9A-9D, an assembly method according to some embodiments is described. In certain aspects, assembly may include preparing support tubing and rods, preparing an inner vessel around the supports, preparing an outer vessel, enclosing the inner vessel within the outer vessel, attaching a support suspension system and rods, and sealing the outer vessel and last rod supports. For example, as shown in FIG. 9A, tubing is welded around the rods. As shown in FIG. 9B, in this example the inner vessel is welded to the tubing. As shown in FIG. 9C, the outer vessel is placed over the inner vessel and attached. The inner vessel may be suspended from the outer vessel with a rope suspension system 902 using rope and a plurality of connection points. As shown in FIG. 9D, the base is added and sealed. In some embodiments, this may be a part of process 850. According to embodiments, the outer vessel may suspend the inner vessel using one or more rope connections.

Referring now to FIG. 10, a tank is illustrated according to some embodiments. This may be a tank, for instance, as shown in FIGS. 2-6, 7A-7E, or 12. In this example, one or more of the support systems are not used in all regions of the tank. For instance, in some embodiments, inner support rods are not used in every region of the tank. That is, certain walls of the tank are not supported by an internal support structure, while others are. For instance, in areas of the tank that have thin walls, a support structure may be used. In some embodiments, areas of the tank may have thicker walls and not need additional support. As an example, an inner support system may be provided for 50% or less of the storage tank, by volume or surface area. In the example of FIG. 10, inner rods are only used in one section of the tank. This may be because the volume in that region is too small to allow thick walls, so the rods are used to reduce the wall thickness. According to embodiments, a tank may have a first region and a second region, wherein a first region is supported by an internal support structure and the second region is not supported by an internal support structure. The first region may use thinner wall(s) than the second region. The first region may be larger than the second region, or the second larger than the first. The thickness of the walls may refer to the inner or outer vessel, according to some embodiments. According to some embodiments, outer support structures (not shown in FIG. 10) may nonetheless be used in all regions of the tank even though inner support structure is partially used. In some embodiments, a rope suspension system may be used to suspend the inner vessel from the outer vessel without the use of a rod-based outer support system, while an inner support system is still used, for instance, with one or more internal rods or webbing.

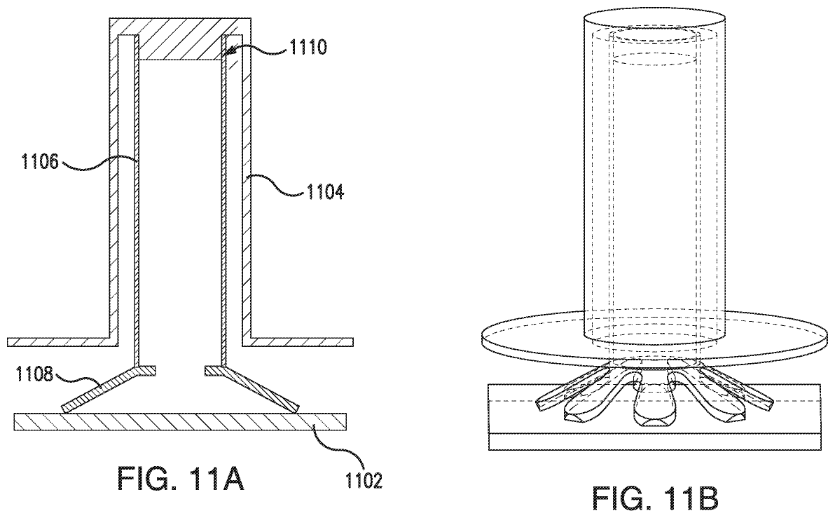

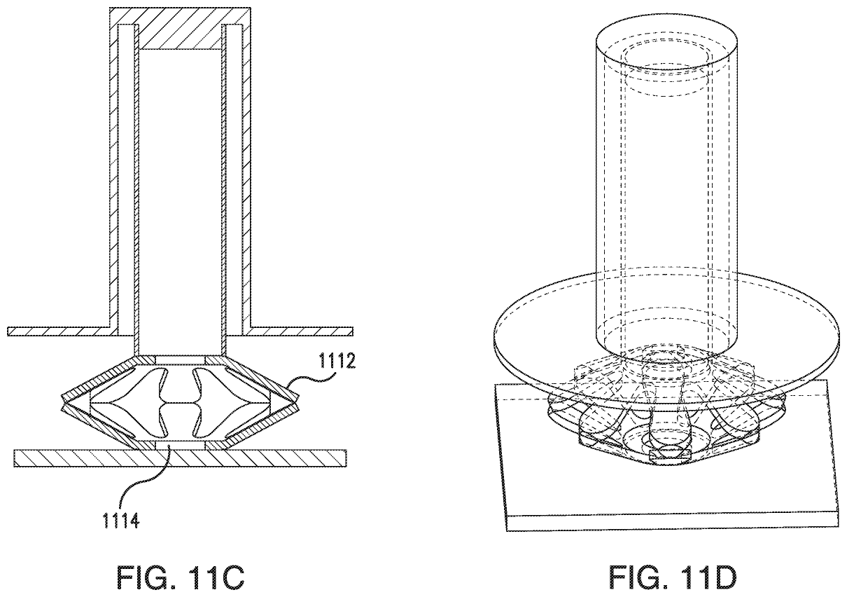

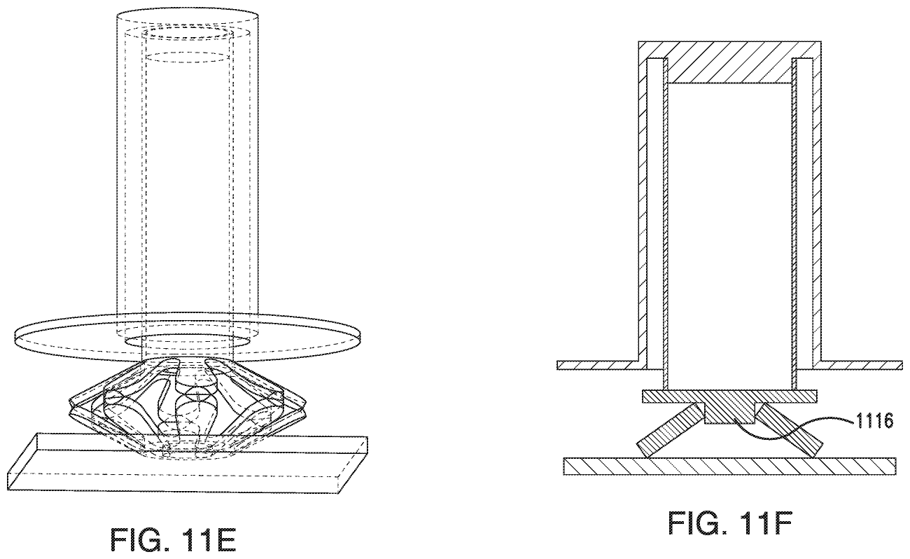

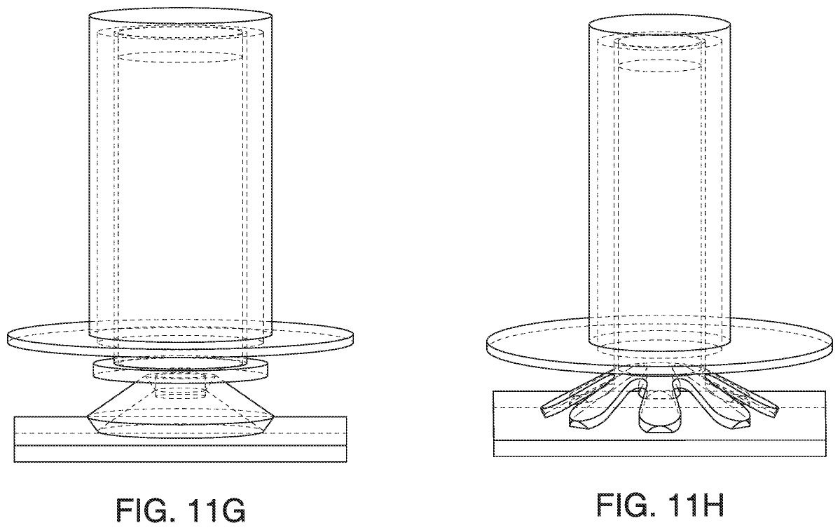

Referring now FIGS. 11A-11H, connections are described according to embodiments. Such connections may be used to attach inner and outer vessels, for example. A connection may be used to suspend an inner vessel within an outer vessel, for instance, as illustrated with respect to FIGS. 2-6. The connection may be, in some embodiments, for a rod, such as a partially or completely hollow rod, at the interface of an outer vessel, such as a rod 430, 440. The connection may be made with a Belleville washer, where the tension or force created by the flexing of the washer is sufficient to secure the inner vessel within the outer vessel. Examples of such washer arrangements are provided in FIGS. 11A-11H.

As illustrated in the example of FIG. 11A, a hollow rod or tube (e.g., a composite tube) 1106 can be used to secure an inner vessel 1104 to an outer vessel 1102. There may be a fixed connection 1110 at the inner vessel, such as glue to create a good thermal link. According to embodiments, the tube gets cold and reduces the radiative heat load (e.g., via conduction through the glue). A washer 1108, such as a Belleville washer (e.g., made of a composite) can be used to provide compliance and support at the attachment point. This can also create a small surface area at the contact points to the outer vessel, which can mean a poor thermal link. With a good thermal link to the inner tank, and a poor thermal link to the outer tank, a beneficial heat gradient along the tube can be achieved. In some embodiments, the tube is cold. While illustrated with washers, other compliant support structures may be used. In some embodiments, a washer may be used on the inner vessel side of the rod 1106. FIG. 11B illustrates an exemplary rendering of the structure shown in FIG. 11A. In FIG. 11C, the washer is a double washer 1112. Additionally a protrusion 1114 from the outer vessel 1102 can be used to prevent movement of the washer 1108, 1112. They may also be used for alignment in some instances, and may correspond to one or more pins of FIGS. 2-6. In another embodiment, the protrusion 1116 is used, which extends from the rod 1106 instead of the outer vessel 1102. In some embodiments, both protrusions 1114, 1116 are used. FIGS. 11D, 11E, 11G, and 11H are additional renderings of attachment structures.

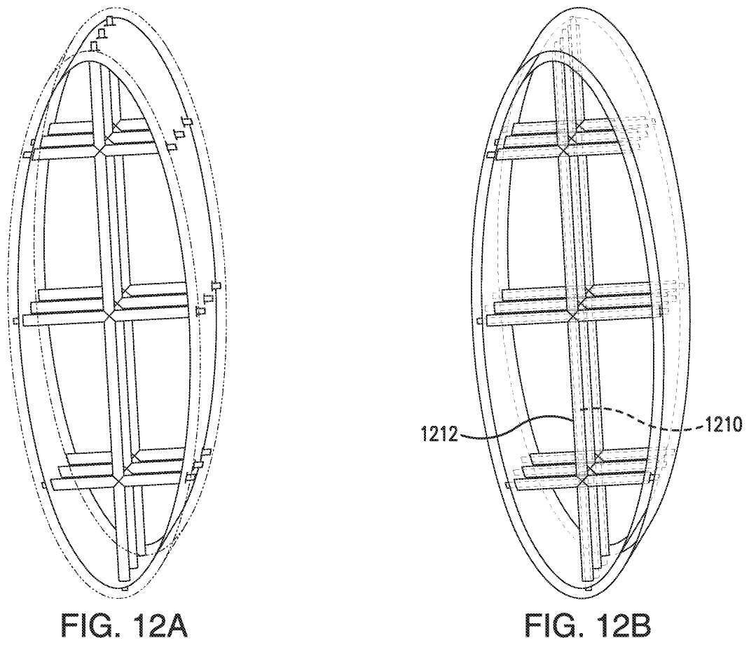

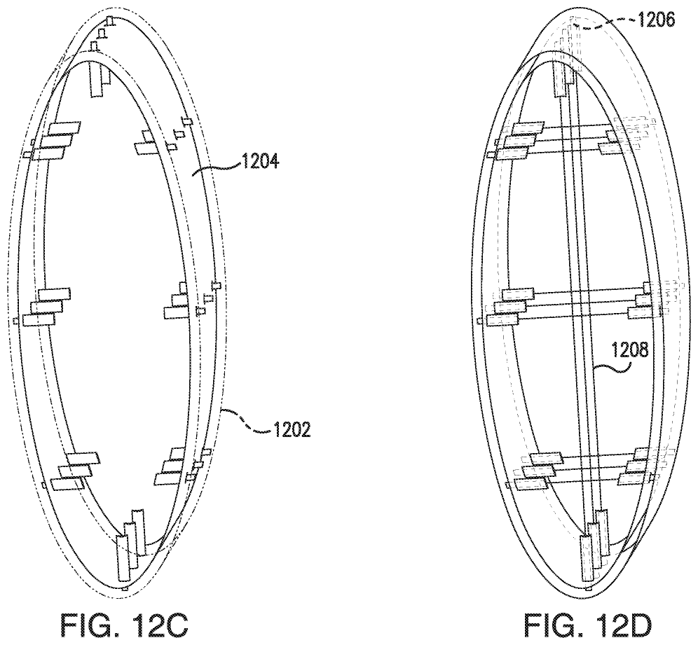

Referring now to FIGS. 12A-12D, a cross-section of a tank according to embodiments is provided. In this example, the cross-section has a rounded (e.g., oval or near-oval) shape. This could be, for instance, a wing. According to embodiments, a tank—as described herein—is a wing of, or a part of a wing of, an aircraft. As shown in FIGS. 12A-12D, the wing tank of this embodiment can use an internal support structure, such as a rod and pin arrangement as described with other embodiments, which can use webbing in some instances. In FIGS. 12A and 12B, rods 1210 extend through tubes 1212 as a support system. According to embodiments, this may be implemented as described in connection with FIGS. 7A-7E. In FIGS. 12C and 12D, an inner vessel 1204 is suspended within an outer vessel 1202. In some embodiments, rods 1206 may be used for the outer support system and a webbing or partial webbing 1208 is used for the inner support system. This could be, for instance, as implemented as described with respect to FIGS. 2-6 and 10. In some embodiments, the inner vessel 1204 may be suspended from outer vessel 1202 with a rope suspension system having a plurality of connection points, while the inner support system 1208 is used internally.

According to embodiments, including those discussed with respect tank 400, FIGS. 6A-6C, and FIG. 12D, the internal support structure can act to pull the walls of the inner vessel inwards. This could be, for instance, due to the cooling of the materials used to form the inner support structure or a tensioning of the inner support structure elements. This can counteract the force exerted on the inner vessel due to the pressure of its contents, such as methane. The tension provided by an inner webbing can provide additional strength to the overall structure, which can be an improvement over existing designs in which a vessel's contents apply pressure to its unsupported walls. In this respect, the outer vessel is also strengthened as it is pushed outwards by the support structure against the atmospheric pressure that is acting on it, effectively pushing its walls inwards due to the gap (e.g., vacuum) between the inner and outer vessel. According to embodiments, the support structure achieves this while maintaining a gap between the inner and outer vessels, which may be necessary to preserve the thermal insulation between the two vessels. In certain aspects, the strength of the inner vessel is effectively transferred to the outer vessel via the support structure and the strength of the outer structure is effectively transferred to the inner structure by the support structure. The internal webbing thereby effectively increases the overall strength of the entire structure that would otherwise not be present in a conventional vacuum insulated cryogenic tank. This can be beneficial for instance, when the tank is used perform a function such as the wing of an airplane, the supporting member in a vehicle, or any other structural member. The additional degrees of freedom provided by this approach mean that the inner tank, outer tank, support structures and webbing can be adjusted as a whole, resulting in the entire structure being optimized for the application in mind with respect to shape, weight, rigidity, flexibility etc.

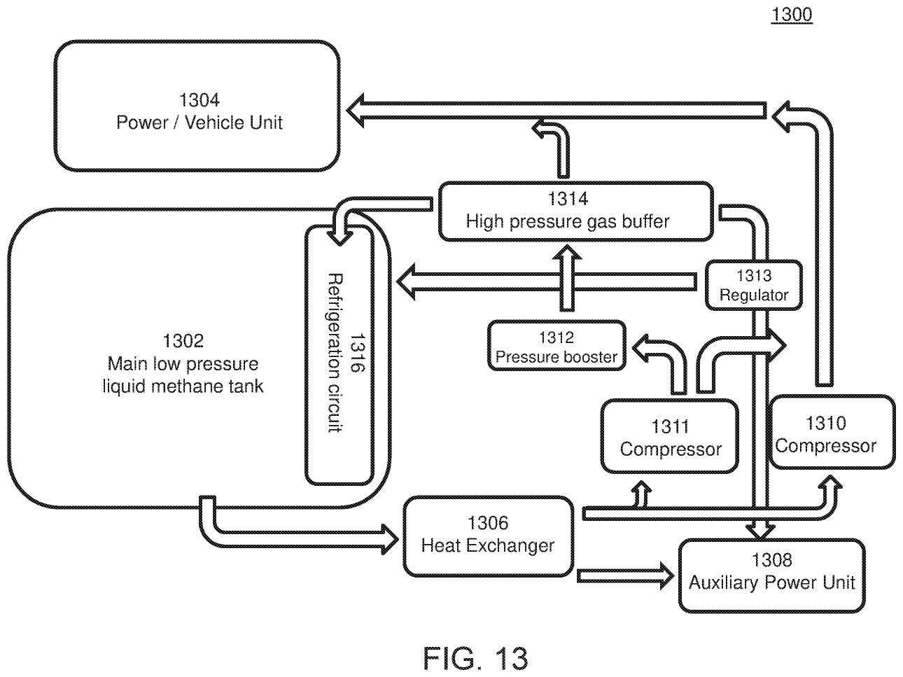

Referring now to FIG. 13, a system 1300 for the storage and delivery of a fuel, for instance methane, is provided according to some embodiments. The system may comprise a low pressure fuel storage tank 1302. In some embodiments, tank 1302 has a non-cylindrical cross-section, such as a square or rounded rectangular cross-section. Although square and rounded rectangle shapes are used in this example, other non-cylindrical cross-sections could be used. Additionally, the tank 1302 could have a complex shape, for instance, an “L” shape or function as an operative component of a vehicle, such as a wing or wall. According to embodiments, the tank 1302 is any of the tanks illustrated and discussed in connection with FIGS. 2-7, 10, and 12.

The system may also include a heat exchanger 1306, an auxiliary power unit 1308, a liquefaction/refrigeration circuit 1316, a gas compressor 1310, and a high pressure buffer and booster 1314 and 1312. The system may be configured so that the liquid methane is held at the lowest possible temperature, thereby increasing the energy density to its maximum.

In some embodiments, upon receiving a demand for gaseous methane, the compressor 1310 is powered up, forcing gas into the engine 1304. The engine may be a combustion or non-combustion engine according to embodiments. In some embodiments, a flameless heat engine is used, in which a catalyst is used to heat the gas before passing it to a gas turbine. Gas may also be forced back into the tank via a regulator, pressurizing the tank to force more liquid methane out through the heat exchanger 1306, where it is vaporized before being compressed and forced into the engine to continue the cycle. That is, gas may be passed to the tank 1302 from compressor 1310 (or 1311) via regulator 1313. In this way, the components of system 1300 may be used in conjunction to simultaneously deliver the necessary fuel to unit 1304, such as an engine, while ensuring that additional fuel will be vented from tank 1302 for sustained delivery and use.

According to some embodiments, a second compressor 1311 may be used. The second compressor can be coupled to the tank 1302. In some embodiments, the second compressor 1311 is placed in parallel with the first compressor 1310. It may be used, for example, to deliver methane gas under high demand. In some embodiments, the second compressor 1311 may be arranged to act independently of the first compressor 1310 to supply methane gas to a pressure booster, such as booster 1312. This may be, for instance, to achieve high pressure for storage in the high pressure buffer 1314 or to drive a cooling unit, such as refrigeration circuit 1316. As illustrated in FIG. 13, and in some cases, regulator 1313 may be further connected to compressor 1311 and used to direct gas to one or more of buffer 1314 and tank 1302. Although depicted as a single component, in some instance, regulator 1313 may comprise a plurality of regulation components, including one or more valves. According to some embodiments, the first and second compressors 1310, 1311 can be located anywhere on the vehicle serviced by the necessary pipework, control, and power cables. In some instances, one or more of the compressors takes gas at low pressure, for example, 3 bar, and delivers it to an engine at higher pressure, such as 10 bar. This could be, in some embodiments, with a combined output rate of 16 grams per second.

By way of example, during normal vehicle cruising operation one compressor, such as compressor 1310, could be sufficient to deliver methane at a first level, such as at 8 grams per second to the engine. In this instance, the second compressor, such as compressor 1311, could be reserved for additional tasks, as required. As an example, the second compressor could be used to supply gas to a regulator, or a pressure booster and fill a high pressure buffer. According to some embodiments, when there is a need to cool a fuel stored in a tank, such as liquid methane in tank 1302, high pressure methane from the buffer or from the output of a pressure booster can be passed through a refrigeration element, such as a Joule Thompson refrigeration circuit inside the tank, re-condensing the methane to a liquid that is colder than the main reservoir. This could increase the hold time left before the methane would need to be vented, or make additional space available for fresh fuel because the colder methane is denser.

According to some embodiments, initial start-up of a vehicle, including for instance starting power/vehicle unit 1304, can be achieved using fuel stored in a high pressure buffer, such as buffer 1314, which can store methane gas. This could allow, for example, the first compressor 1310 to start independently of the pressure in the main tank 1302, which may be low according to some embodiments. In certain aspects, once the compressor 1310 is running, a regulator 1313 can be used to bleed some gas into the main tank. In some embodiments, gas is bled to the main tank 1302 at 3 bar. In some respects, the main tank pressure is therefore set independently of the liquid methane vapor pressure. According to embodiments, for instance in situations that require high gas flow, a pressure raising circuit can be incorporated. This can enable the pressure of the tank to be increased by boiling off some of the liquid, for example through a heat exchanger attached to the inside wall of an outer vacuum vessel. In this way, pressure in the tank can be maintained during periods of high usage

In certain aspects, auxiliary power unit 1308 can serve a number of roles. According to embodiments, it can be positioned anywhere on a vehicle and connected via the necessary pipes. It can be used to extract energy from the methane gas that would otherwise have to be vented when the pressure in the methane tank is rising but the vehicle or generator is not being used. Electrical energy may be generated by unit 1308, for instance, with a fuel cell arrangement and/or a secondary engine by using some of the methane. The electrical energy can be stored in a battery.

According to some embodiments, auxiliary power unit 1308 can be also be used to provide power and/or heat to a vehicle's quarters, including for instance a cabin or “hotel” load when the driver is sleeping overnight. For very cold starts, for example, it can be run exclusively from the high pressure buffer to generate heat for the heat exchanger, e.g. heat exchanger 1306, that vaporizes the liquid methane before the vehicles main engine is sufficiently warm.

According to some embodiments, system 1300 may operate in a state in which a tank is at an increased pressure. For example, they system may operate when the storage tank 1302 has been left for a period of time allowing heat to boil the stored fuel, such as liquid methane, thereby increasing the pressure. According to embodiments, a valve is opened for feeding the excess methane gas to an auxiliary power unit (such as a combustion engine or fuel cell) where power is generated and stored in a battery. This could be unit 1308, for instance. Power from the battery can then be used to power a compressor to take excess gas from the tank and pass it through a pressure booster (e.g., booster 1312) and cooling unit (e.g., refrigeration circuit 1316) to re-liquefy excess gas and return it to the main reservoir. This can advantageously reduce the main reservoir's temperature and extend its non-venting storage time. Alternatively, and according to some embodiments, a compressor and booster can be used to take low pressure gas from the main tank and store it in a highly compressed gaseous state in a high pressure buffer, such as buffer 1314, that acts as an independent reservoir that can be used to initiate the starting sequence of the main engine or supply the auxiliary power unit as required.

Although one larger low pressure compressor could be used, according to some embodiments, to supply sufficient gas to the engine when under maximum demand the use of two lower flow compressors acting independently may be used. In some cases, under normal operation, one compressor can fulfil the sufficient fuel delivery, saving energy. Further, to provide a high pressure buffer volume, the second compressor can be used independently. By pumping gas through a pressure booster, a high pressure reservoir can be filled. This can then be used to either power the engine during a cold start or keep the liquid reservoir cold by passing through a Joule Thompson refrigeration system positioned within the inner liquid methane tank. This system can be used to keep the main reservoir cold, thereby sustaining low pressure operation.

Although methane is used as an example, the storage elements described herein can be used for storage, including cryogenic storage, of other materials as well. For instance, hydrogen fuels may be used, and other materials (e.g., oxygen, helium, argon, and nitrogen) may be stored according to the embodiments described herein. Similarly, fuel storage and delivery systems according to embodiments also apply to non-methane fuels.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-61. (canceled)

62. A storage tank, comprising:
an inner vessel, wherein the inner vessel comprises an outer wall with a plurality of recesses;
an outer vessel, wherein the inner vessel is arranged within the outer vessel; and
a first support system, wherein the first support system comprises a plurality of rods connecting the inner vessel to the outer vessel, and
wherein the plurality of rods are attached to the inner vessel in the recesses.

63. The storage tank of claim 62, further comprising:
a second support system located at least partially within the inner vessel.

64. The storage tank of claim 63,
wherein second support system comprises one or more rods or rope.

65. The storage tank of claim 62, wherein one or more of the plurality of rods of the first support system is a hollow tube.

66. The storage tank of claims 62, wherein at least one of the outer vessel and inner vessel comprises at least one pin, and wherein at least one the plurality of rods is arranged over a pin of the outer vessel or inner vessel.

67. The storage tank of claim 66, wherein the at least one pin is made of steel and welded to the outer vessel.

68. The storage tank of claim 62, wherein the outer vessel comprises a first plurality of pins or washers, the inner vessel comprises a second plurality of pins or washers, and each of the rods is connected to a pin or washer of the first plurality and a pin or washer of the second plurality.

69. The storage tank of claim 68, wherein the first and second pluralities of pins or washers are aligned.

70. The storage tank of claim 62, wherein at least one of the outer and inner vessels is non-cylindrical.

71. The storage tank of claim 62, wherein the outer vessel comprises at least six flat surfaces.

72. The storage tank of claim 62, wherein the storage tank is an operative component of a vehicle and the storage tank is operative for purposes additional to fuel delivery or fuel storage.

73. The storage tank of claim 72, wherein the storage tank is a wing or structural wall of a vehicle.

74. The storage tank of claim 73, wherein the first support system comprises an n×m×o array of rods, and wherein the second support system comprises an a×b×c array of rods or ropes.

75. The storage tank of claim 74, wherein the array of at least one of the first or second support systems has an orthogonal arrangement.

76. The storage tank of claim 63, wherein the second support systems is provided in a first region of the tank but not in a second region of the tank.

77. A vehicle, comprising:
an engine; and
a fuel delivery system coupled to the engine that comprises a storage tank,
wherein the storage tank comprises:
an inner vessel, wherein the inner vessel comprises an outer wall with a plurality of recesses;
an outer vessel, wherein the inner vessel is arranged within the outer vessel; and
a first support system, wherein the first support system comprises a plurality of rods connecting the inner vessel to the outer vessel, and
wherein the plurality of rods are attached to the inner vessel in the recesses.

78. The vehicle of claim 77, wherein the storage tank further comprises a second support system located at least partially within the inner vessel, and wherein the second support system comprises one or more rods or rope.

79. The vehicle of claim 77, wherein the storage tank is an operative component of the vehicle that is operative for purposes additional to fuel delivery or fuel storage.

80. The vehicle of claim 79, wherein the storage tank is a wing or structural wall of the vehicle.

81. The vehicle of claim 77, wherein the storage tank does not comprise bunding.
